(19) United States
(12) Patent Application Publication
(10) Pub. No.: US 2026/0286939 A1
(43) Pub. Date: Sep. 24, 2026

(54) LIGHTNING STRIKE PROTECTION SYSTEM

(71) Applicant: VESTAS WIND SYSTEMS A/S, Aarhus N (DK)

(72) Inventors: Nathan A. BRILLIANT, Arvada, CO (US); Julian Anaya CALVO, Valladolid (ES)

(21) Appl. No.: 19/475,234

(22) PCT Filed: Mar. 27, 2024
(86) PCT No.: PCT/DK2024/050076

§ 371 Date: Oct. 14, 2025

Related U.S. Application Data
(60) Provisional application No. 63/496,162, filed on Apr. 14, 2023.

(30) Foreign Application Priority Data
May 22, 2023 (DK) PA202370243

(51) Int. Cl. F03D 80/30; F03D 1/06

(52) U.S. Cl. CPC F03D 80/30; F03D 1/0664; F05B 2260/70

(57) ABSTRACT

A pitch controlled wind turbine comprising a tower, a nacelle mounted on the tower, a hub mounted rotatably on the nacelle, and at least three wind turbine blades, wherein each wind turbine blade extends between a root end connected to the hub via a pitch mechanism, and a tip end; the wind turbine further comprising at least three blade connecting members, each blade connecting member extending from a connection point on one wind turbine blade towards a connection point on a neighbouring wind turbine blade, where the connection point on a given wind turbine blade is arranged at a distance from the root end and at a distance from the tip end of the wind turbine blade; each wind turbine blade comprising an outboard portion extending the distance from the tip end of the wind turbine blade to the connection point, and an inboard portion extending the distance from the root end of the wind turbine blade to the connection point; wherein the wind turbine further comprises a lightning strike protection system and each blade connecting member has a conductive material configured to carry lightning current from the outboard portion of the wind turbine blade from which the connecting member extends and along a path extending with the blade connecting member towards the tower.

### FIELD OF THE INVENTION

The present invention relates to a pitch controlled wind turbine.

### BACKGROUND OF THE INVENTION

Wind turbine blades are susceptible to lightning strikes. To protect the wind turbine blades, a lightning strike protection system couples the wind turbine blades to ground. Typically, the lightning strike protection system includes lightning receptors and conductors that are electrically connected from the tip of the blade, through the tower and nacelle, to ground. Further means of electrically conducting to ground can include surface protection layers, for instance a metal mesh or foil surface protection layer incorporated into the blade shell at the outer surface of the blade and extending along at least a portion of the blade. The surface protection layer intercepts lightning strikes before reaching conductive components of the blade and is typically connected to the lightning strike protection system at numerous points so as to ensure a good electrical connection from the surface protection layer. These systems are typically integrated into or onto the wind turbine blades themselves, whilst any connections between components of the lightning strike protection system, as well as between blade segments of split blades, need to be carefully designed to ensure a continuous electrical path across the connection. Consequently, significant challenges arrive in the design, manufacture and maintenance of wind turbines having a lightning strike protection system.

It is against this background that the invention has been devised.

### SUMMARY OF THE INVENTION

A first aspect of the invention provides a pitch controlled wind turbine comprising a tower, a nacelle mounted on the tower, a hub mounted rotatably on the nacelle, and at least three wind turbine blades, wherein each wind turbine blade extends between a root end connected to the hub via a pitch mechanism, and a tip end; the wind turbine further comprising at least three blade connecting members, each blade connecting member extending from a connection point on one wind turbine blade towards a connection point on a neighbouring wind turbine blade, where the connection point on a given wind turbine blade is arranged at a distance from the root end and at a distance from the tip end of the wind turbine blade; each wind turbine blade comprising an outboard portion extending the distance from the tip end of the wind turbine blade to the connection point, and an inboard portion extending the distance from the root end of the wind turbine blade to the connection point; wherein the wind turbine further comprises a lightning strike protection system and each blade connecting member has a conductive material configured to carry lightning current from the outboard portion of the wind turbine blade from which the connecting member extends and along a path extending with the blade connecting member towards the tower.

Optionally, the wind turbine further comprises at least three pre-tension members, each pre-tension member being connected to one of the blade connecting members and to the hub, each pre-tension member thereby providing pre-tension in the blade connecting member to which it is connected, and wherein each pre-tension member has a conductive material forming part of the lightning strike protection system and configured to carry lightning current from the blade connecting member to which the pre-tension member is connected and along a path extending with the pre-tension member towards the tower.

Optionally, the conductive material of the blade connecting members and/or the pre-tension members is embedded within the respective blade connecting member or pre-tension member.

Optionally, the conductive material of the blade connecting members and/or the pre-tension members is attached to an outer surface of the respective blade connecting member or pre-tension member.

The conductive material may be both embedded within and attached to the outer surface of the respective blade connecting member or pre-tension member. A first portion of the conductive material may be embedded whilst a second portion may be attached to the outer surface.

Optionally, wherein the conductive material is coupled to the respective blade connecting member or pre-tension member either inside or outside a profile of the respective blade connecting member or pre-tension member.

Optionally, the conductive material is coupled to the outside of the respective blade connecting member or pre-tension member by a stand-off.

Optionally, the conductive material is formed as one or more of a plurality of strands, a cable, or a braided sleeve.

Optionally, the conductive material is helically wound along the respective blade connecting member or pre-tension member.

Optionally, in a first region of the respective blade connecting member or pre-tension member, the conductive material is helically wound, and at a second region of the respective blade connecting member or pre-tension member, the conductive material extends co-axially to a longitudinal axis of the respective blade connecting member or pre-tension member.

Optionally, the conductive material is helically wound at a first pitch at a first portion of the respective blade connecting member or pre-tension member and the conductive material is helically wound at a second pitch, different to the first pitch, at a second portion of the respective blade connecting member or pre-tension member.

Optionally, the blade connecting members and/or the pre-tension members comprise metallic material and the metallic material is the conductive material of the blade connecting members and/or the pre-tension members.

Optionally, the blade connecting members and/or the pre-tension members comprise polymer material.

Optionally, the outboard portion and the inboard portion of each wind turbine blade are connected to each other at a split position, and wherein the connection points on the wind turbine blades are arranged at the split positions.

Optionally, the inboard portion of each wind turbine blade has a reduced lightning current carrying capacity in comparison to a lightning current carrying capacity of the outboard portion of the wind turbine blade.

Optionally, the inboard portion of each wind turbine blade is not configured to carry lightning current from the outboard portion of the wind turbine blade towards the tower. For example, the outboard portion of each blade is provided with a down conductor extending from the tip end of each blade to the respective connection point, and the inboard portion of each blade is not provided with a down conductor.

### BRIEF DESCRIPTION OF THE DRAWINGS

Embodiments of the invention will now be described with reference to the accompanying drawings, in which:

FIG. 1 shows a front view of a wind turbine according to a first example;

FIG. 2 shows a side view of the wind turbine;

FIG. 3 shows a wind turbine according to a second example;

FIG. 4 shows a segmented wind turbine blade;

FIG. 5 shows an exploded view of a connection joint between blade portions;

FIG. 6 shows a perspective view of a connection joint between blade portions;

FIG. 7 shows a lightning protection system according to a first example;

FIG. 8 shows a lightning protection system according to a second example;

FIG. 9 shows a set of conductive strands embedded in a connecting member or pre-tension member;

FIG. 10 shows a cable attached within a profile of a connecting member or pre-tension member;

FIG. 11 shows a cable fixed to an outer surface of a connecting member or pre-tension member;

FIG. 12 shows a cable spaced from an outer surface of a connecting member by a stand-off;

FIG. 13 shows strands helically wound around a connecting member or a pre-tension member;

FIG. 14 shows strands helically wound at different pitches along the length of a connecting member or pre-tension member;

FIG. 15 shows stands intermittently helically wound between regions of non-helical strands extending co-axially to the connecting member or pre-tension member longitudinal axis;

FIG. 16 shows a braided sleeve around a connecting member or pre-tension member.

### DETAILED DESCRIPTION OF EMBODIMENT(S)

In this specification, terms such as leading edge, trailing edge, pressure surface, suction surface, thickness, and chord are used. While these terms are well known and understood to a person skilled in the art, definitions are given below for the avoidance of doubt.

The term leading edge is used to refer to an edge of the blade which will be at the front of the blade as the blade rotates in the normal rotation direction of the wind turbine rotor.

The term trailing edge is used to refer to an edge of a wind turbine blade which will be at the back of the blade as the blade rotates in the normal rotation direction of the wind turbine rotor.

The chord of a blade is the straight line distance from the leading edge to the trailing edge in a given cross section perpendicular to the blade spanwise direction. The term chordwise is used to refer to a direction from the leading edge to the trailing edge, or vice versa.

A pressure surface (or windward surface) of a wind turbine blade is a surface between the leading edge and the trailing edge, which, when the blade is in use, has a higher pressure than a suction surface of the blade.

A suction surface (or leeward surface) of a wind turbine blade is a surface between the leading edge and the trailing edge, which will have a lower pressure acting upon it than that of a pressure surface, when the blade is in use.

The thickness of a wind turbine blade is measured perpendicularly to the chord of the blade and is the greatest distance between the pressure surface and the suction surface in a given cross section perpendicular to the blade spanwise direction.

The term spanwise is used to refer to a direction from a root end of a wind turbine blade to a tip end of the blade, or vice versa. When a wind turbine blade is mounted on a wind turbine hub, the spanwise and radial directions will be substantially the same.

The term spar cap is used to refer to a longitudinal, generally spanwise extending, reinforcing member of the blade. The spar cap may be embedded in the blade shell or may be attached to the blade shell. The spar caps of the windward and leeward sides of the blade may be joined by one or more shear webs extending through the interior hollow space of the blade. The blade may have more than one spar cap on each of the windward and leeward sides of the blade. The spar cap may form part of a longitudinal reinforcing spar or support member of the blade. In particular, spar caps may form part of the load bearing structure extending in the longitudinal direction that carries the flapwise bending loads of the blade. The spar cap may comprise spar cap portions either side of a connection joint between portions of the blade.

The term outboard refers to a radial direction from the hub of the blade towards the tip end of the blade. The term inboard refers to a radial direction from the tip end towards the hub.

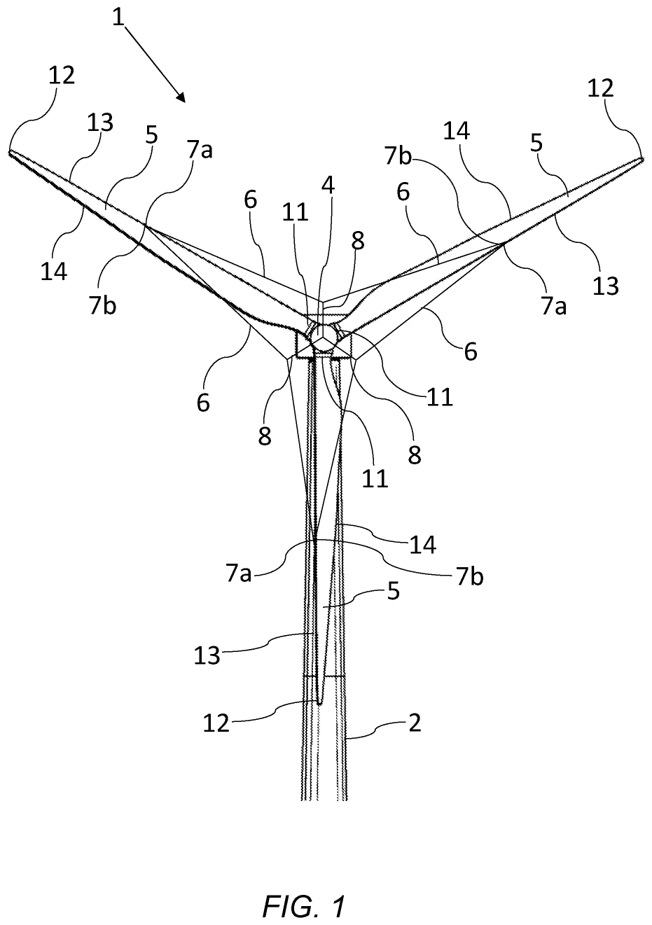

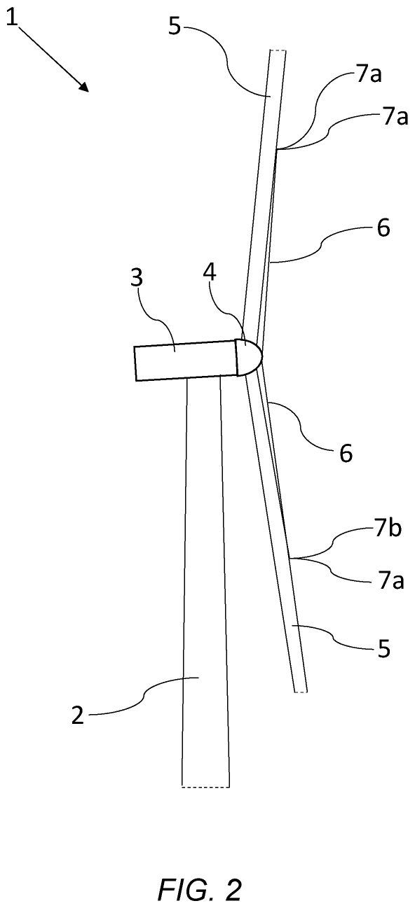

FIGS. 1 and 2 show a pitch controlled wind turbine 1 according to a first example. FIG. 1 is a front view of the wind turbine 1, and FIG. 2 is a side view of the wind turbine 1. The wind turbine 1 comprises a tower 2 and a nacelle 3 mounted on the tower 2. A hub 4 is mounted rotatably on the nacelle 3, and carries three wind turbine blades 5 projecting outwardly from the nacelle 3. While the example shown in FIGS. 1 and 2 has three blades 5, it will be appreciated that other numbers of blades 5 are possible.

When wind blows against the wind turbine 1, the wind turbine blades 5 generate a lift force which causes a generator (not shown) within the nacelle 3 to generate electrical energy.

It will be appreciated that the wind turbine 1 depicted may be any suitable type of wind turbine 1. The wind turbine 1 shown is an upwind wind turbine, although it will be appreciated the wind turbine 1 may be a downwind wind turbine. The wind turbine 1 may be an onshore wind turbine such that the foundation is embedded in the ground, or the wind turbine 1 may be an offshore installation in which case the foundation would be provided by a suitable marine platform.

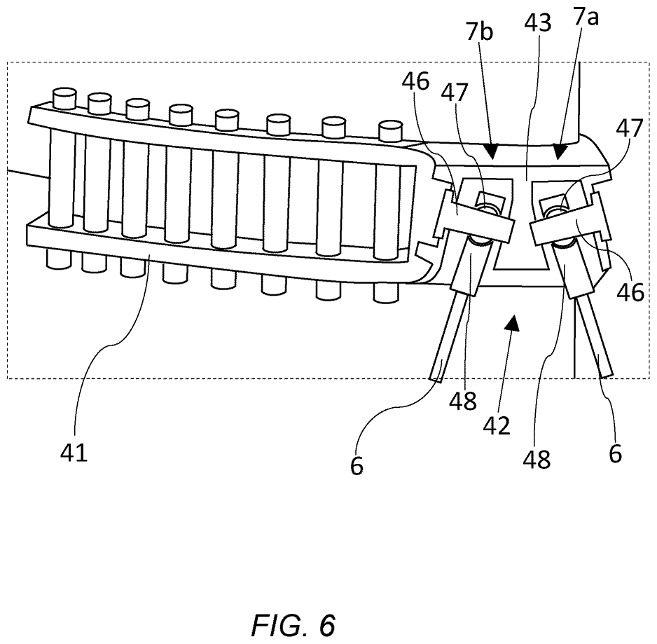

Three blade connecting members 6 interconnect neighbouring wind turbine blades 5 between connection points 7a, 7b on the wind turbine blades 5 (such as shown in further detail in FIG. 6). The connecting members 6 are cables, e.g. metal cable (for example comprising steel), or polymer (for example comprising high density polyethylene-HDPE).

A pre-tension member 8 may extend between one of each of the blade connecting members 6 and a common point arranged at or adjacent the hub 4. In the example shown in FIGS. 1 and 2, the pre-tension members 8 extend to the hub 4. The pre-tension members 8 are configured to provide pre-tension in the blade connecting members 6.

The pre-tensioned blade connecting members 6 cause the wind turbine blades 5 to mutually support each other, in the sense that loads on the wind turbine blades 5, in particular edgewise loads and flapwise loads, are ‘shared’ among the wind turbine blades 5.

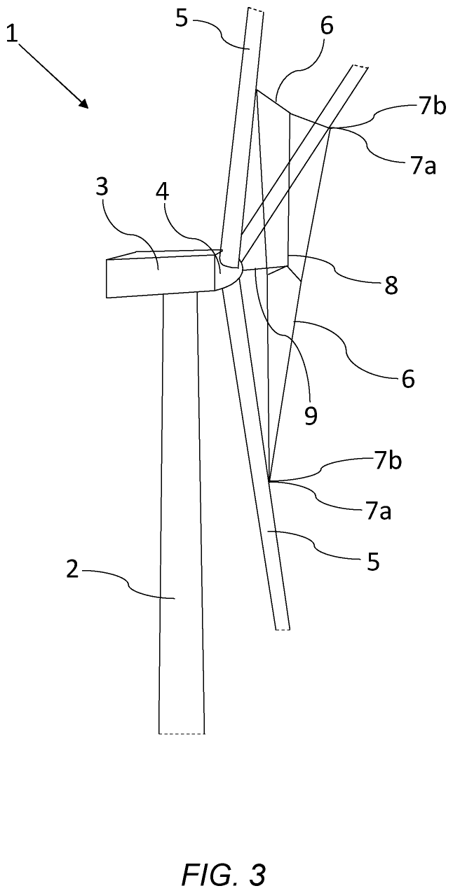

FIG. 3 is a side view of a pitch controlled wind turbine 1 according to a second example. The wind turbine 1 of FIG. 3 is similar to the wind turbine 1 of FIGS. 1 and 2, and therefore likewise features will not be described in detail here.

In FIG. 3, the pre-tension members 8 are not connected directly to the hub 4. Instead, the pre-tension members 8 are connected adjacent the hub 4, to a hub member 9 which extends from the hub 4 substantially along a direction defined by a rotational axis of the hub 4. As a result, the connection point of the pre-tension members 8 is further from the hub 4 than the example of FIGS. 1 and 2, and thereby further from the positions where the wind turbine blades 5 are connected to the hub 4. This has the consequence that the pre-tension members 8 may also pull the blade connecting members 6 away from the hub 4 and away from the tower 2. This may also cause the wind turbine blades 5 to be pulled in this direction, thereby further reducing edgewise and flapwise loads at the root of the wind turbine blades 5 and securing tower clearance, similar to what is obtained when a coning angle is introduced. Due to the use of connecting members 6, this has been found to tend to lead to increased stiffness in the inner part of the blades 5.

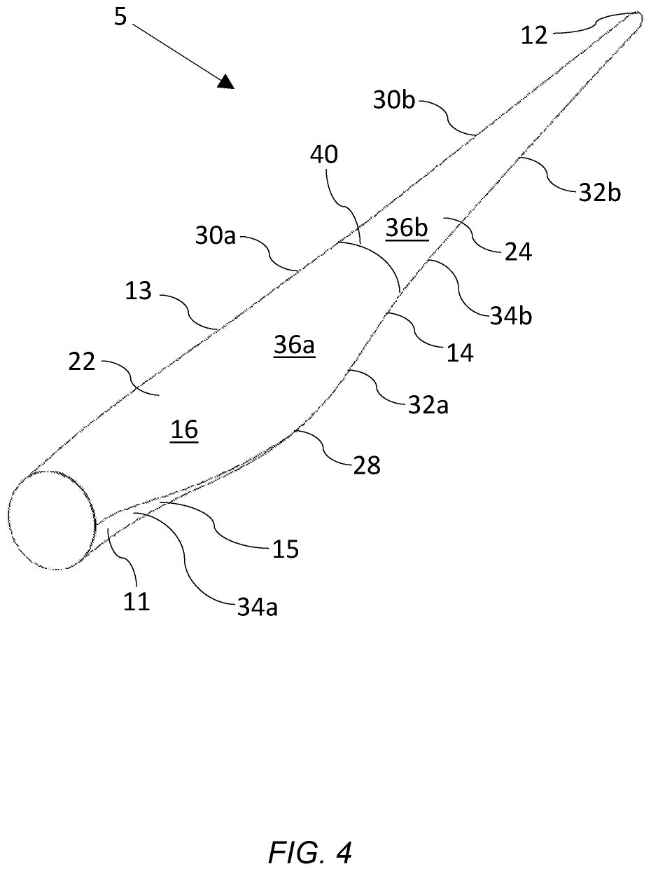

As shown in FIG. 4, the wind turbine blades 5 have a root end 11 proximal to the hub 4, adapted to be connected to the hub 4 via a pitch mechanism, and a tip end 12 distal from the hub 4. The blades 5 include a leading edge 13 and a trailing edge 14 that extend between the respective root end 11 and tip end 12. The blades 5 include a suction side 15 and a pressure side 16. A thickness dimension of the blade 5 extends between the suction side 15 and the pressure side 16.

As shown in FIG. 4, each blade 5 may have a cross section which has a substantially circular profile near the root end 11. The blade 5 may transition from a circular profile to an aerofoil profile moving from the root end 11 of the blade 5 outboard. The blade 5 may comprise a “shoulder” 28 outboard of the root end 11, which is the widest part of the blade where the blade 5 has its maximum chord. The blade 5 may have an aerofoil profile of progressively decreasing thickness in an outboard portion of the blade. The progressively decreasing thickness may extend from the shoulder 28 to the tip end 12.

The connecting points 7a, 7b may be between 10% and 60% of the length of the wind turbine blade 5 from the root end 11 to the tip end 12 in the radial direction but are preferably radially inboard of 50% of the length of the wind turbine blade 5 from the root end 11 to the tip end 12, and more preferably radially inboard of 45% of the length of the wind turbine blade 5 from the root end 11 to the tip end 12, e.g. around 35-40%.

Each of the blades 5 is a split blade formed of a first blade portion 22 and an outboard blade portion 24 coupled together, such as shown in FIG. 4. Each blade portion 22, 24 has a shell that defines a respective leading edge 30a, 30b, trailing edge 32a, 32b, suction side 34a, 34b, and pressure side 36a, 36b.

The inboard portion 22 and outboard portion 24 of each blade 5 may be connected at a connection joint indicated by connection line 40. The connection line 40 between the inboard and outboard blade portions 22, 24 may be a spanwise split, with the connection line 40 being chordwise. The inboard blade portion 22 extends from the blade root 11 to the connection line 40. The outboard blade portion 24 extends from the blade connection line 40 to the blade tip 12.

It will be appreciated that the blade 5 may have any number of blade portions 22, 24, with respective connection joints between them.

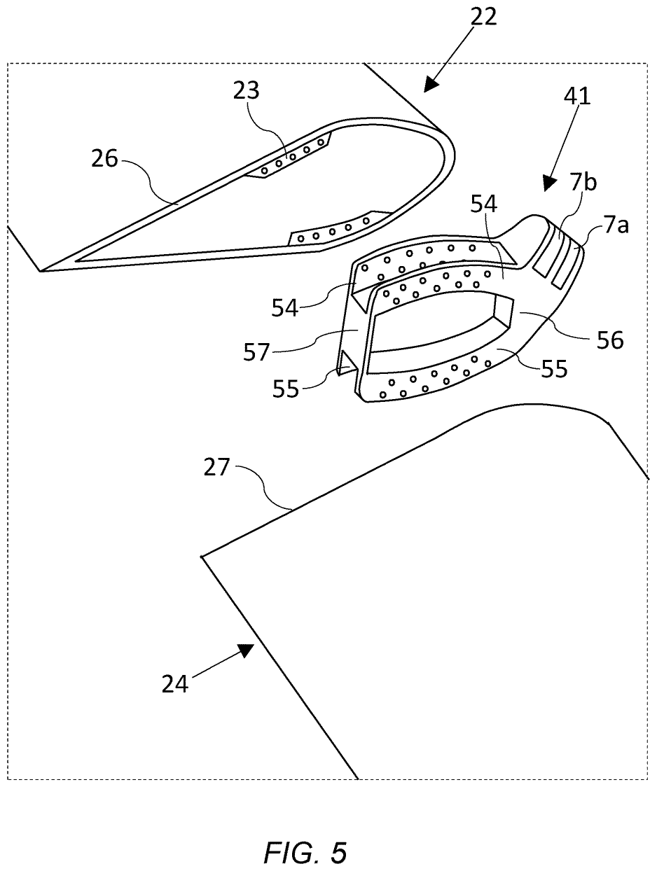

As previously referred to above, the inboard and outboard blade portions 22, 24 are coupled by a connection joint that includes a connector 41, such as shown in FIGS. 5 and 6. In particular, the connector 41 connects a first blade end surface 26 of the inboard blade portion 22 to a second blade end surface 27 of the outboard blade portion 24. As explained in further detail below, the connection points 7a, 7b of the connecting members 6 are on the connector 41 at the connection joint.

The connector 41 is adapted to transfer load between the inboard blade portion 22 and the outboard blade portion 24, and in particular between a first spar cap portion 23 of the inboard blade portion 22 and a second spar cap portion of the outboard blade portion 24.

The connector 41 is a cast metallic component, although it will be appreciated that the connector 41 may be formed of any suitable material, e.g. composite materials, and produced by any suitable manufacturing technique, e.g. machined, co-cured or co-bonded. The connector 41 in the present example is electrically conductive and forms part of an electrical connection between the tip end 12 of the blade 5 and the connecting members 6. In the event that the connector 41 is formed of a material that is non-conductive or has a low conductance, a separate electrical connection is formed through the blade 5 between the tip end 12 and the connecting members 6. The connector 41 is a single unitary connector component 43, although it will be appreciated that the connector 41 may be formed of two or more components in some examples.

In the example shown in FIG. 5, the connector 41 includes a first branch 54 for connecting the suction side 15 of the inboard and outboard blade portions 22, 24 and a second branch 55 for connecting the pressure side 16 of the first and second blade portions 22, 24. The first and second branches 54, 55 may be connected by a first link 56 located towards the leading edge 13 of the blade 5 and connected by a second link 57 located towards the trailing edge 14 of the blade 5. In this way, a ring shape is formed by the first branch 54, second branch 55, first link 56 and second link 57. The first and second branches 54, 55 may be integrally formed with the first and second links 56, 57, although it will be appreciated that the first and second branches 54, 55 may be separate components from each other, and/or the first and second links 56, 57. It will be appreciated that the connector 41 may take other forms.

The connector 41 may extend across substantially the entire chord of the wind turbine blade 5, although preferably the connector 41 extends across only a portion of the chord of the wind turbine blade, such as shown in FIG. 5. This assists in reducing the weight of the connector 41, whilst allowing the connector 41 to be positioned adjacent the spar cap portions 23 of the blade portions 22, 24 that typically carry the majority of the loads.

The connector 41 may extend across any chordwise portion of the blade 5 adjacent the spar cap portions 23, although the example shown in FIG. 5 extends up to the leading edge 13 of the blade 5.

A leading edge extension 42 may extend forward of the leading edge 13 of the blade 5. The leading edge extension 42 is integrally formed with the connector 41, although it will be appreciated that in alternative examples the leading edge extension 42 may be a separate component to the connector 41.

The leading edge extension 42 includes connection points 7a, 7b that attach to the connecting members 6. In the present example, the leading edge extension 42 includes first and second connection points 7a, 7b, although in alternative examples the leading edge extension 42 may comprise any suitable number of connection points. The first and second connection points 7a, 7b may be arranged forward of the leading edge 13 and adjacent the pressure side 16, such as shown in FIG. 5. This provides additional clearance for the connecting members 6 as the wind turbine blades 5 rotate with the hub 4 about the nacelle 3. In particular, sufficient clearance is provided between the connecting members 6 and the inboard blade portion 22 when the blades 5 are pitched between about −5 degrees and about +95 degrees.

It will be appreciated that the connection points 7a, 7b may be adjacent each other on the leading edge extension 42. Alternatively, the connection points 7a, 7b may be spaced from one another. For example, a second connection point 7b may be located further towards the pressure side 16 than the first connection point 7a, e.g. the second connection point 7b may be closer to the pressure side spar cap 23 whereas the first connection point may remain adjacent the leading edge 13.

In some examples, the connector 41 may include multiple leading edge extensions 42 integrally formed with the connector 41. The leading edge extensions may be spaced from each other, for example one may be located further towards the pressure side 16 than the other, with each leading edge extension 42 having a respective connection point 7a, 7b.

The connection points 7a, 7b may permit at least some freedom of movement of the connecting members 6 at its respective connection point 7a, 7b. In the example shown in FIG. 6, the connection points 7a, 7b permit rotation of each blade connecting member 6 about the respective connection point 7a, 7b in two orthogonal rotational degrees of freedom. This allows each connecting member 6 to move independently of each other, thereby reducing constraints on the wind turbine 1.

In addition to ‘sharing’ the loads among the wind turbine blades 5, the connecting members 6 and pre-tension members 8 can also form part of the lightning strike protection system, as will be discussed below.

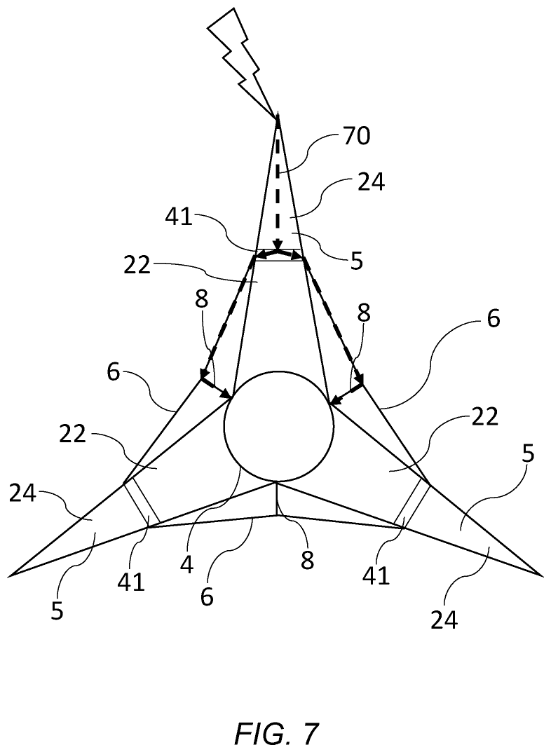

The lightning strike protection system may include a down conductor 70, e.g. a down conductor cable, that runs along the length of the blade 5 from the tip end 12 to the connector 41. In the example shown in FIG. 7, the down conductor 70 extends only from the tip end 12 of the blade 5 to the connector 41, such that no down conductor extends through the blade inboard of the connector 41. In other examples, the down conductor may comprise a surface protection layer instead of or in addition to a cable.

The lightning strike protection system is arranged to earth via a suitable energy handling mechanism (not shown) via the hub 4. The lightning path from the down conductor 70 towards the tower 2 is achieved via at least one of the abovementioned connecting members 6 and/or via at least one of the pre-tension members 8. For example, the lightning path may extend from the outboard portion 24 of the wind turbine blade 5 from which the connecting member 6 extends and along a path extending with the blade connecting member 6 towards the hub 4 and form part of the lightning strike protection system of the wind turbine 1.

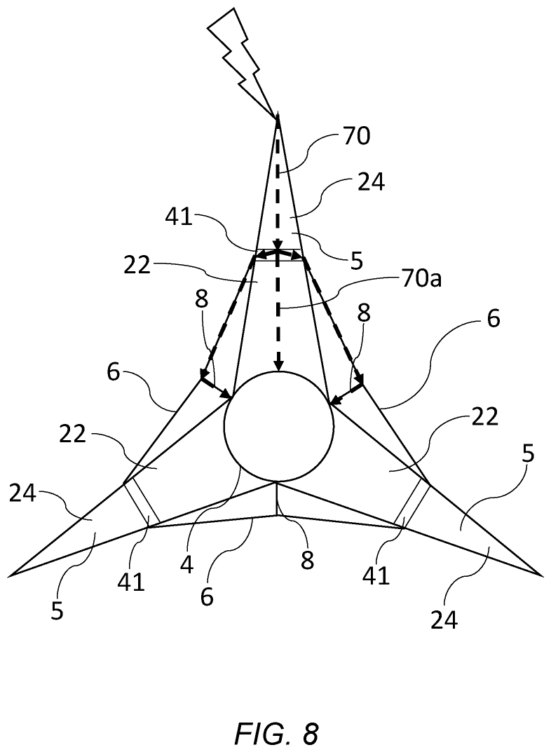

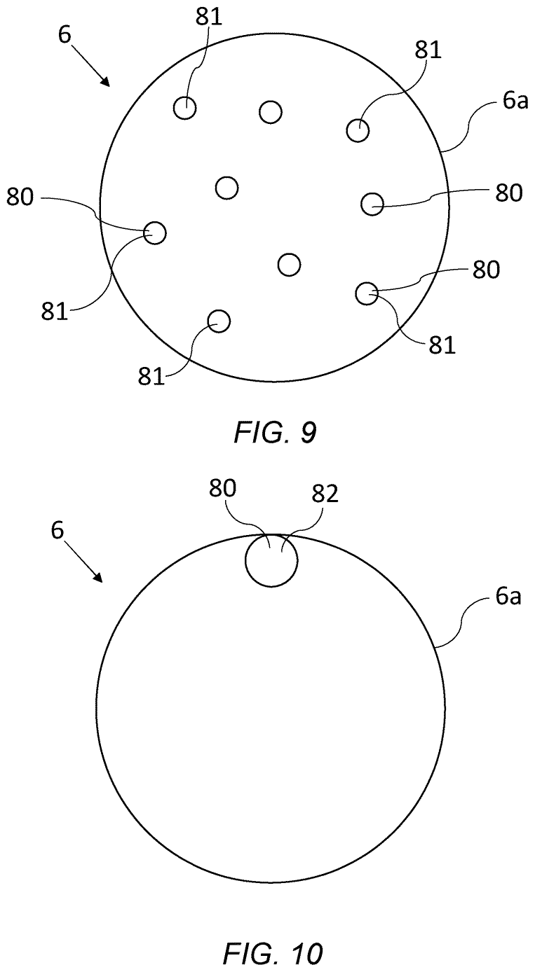

In particular, as shown in FIGS. 9 to 16, the connecting members 6 and/or the pre-tension members 8 have a conductive material forming part of the lightning strike protection system and configured to carry lightning current. The connecting members 6 and pre-tension members 8 may include a main load bearing material 80, e.g. a polymer material or a metallic material. The conductive material is arranged in a substantially non-load bearing capacity, such that the conductive material carries minimal loads in comparison to the main load bearing material 80. The conductive material may be any suitable material, for example a metal such as copper or aluminium. The conductive material may be provided in the form of a plurality of conductive strands 81, a cable 82, or a braided sleeve 83.

In this way, the connecting members 6 and/or pre-tension members 8 facilitate the blades 5 distributing the loads between themselves whilst also eliminating or reducing any requirement for lightning strike protection in the portions of the blade 5 inboard of the connection points 7a, 7b of the connecting members 6. This provides several benefits in terms of the mass, cost and manufacturability of the inboard blade portion, such as the inboard blade portion 22 shown in FIG. 7, as there is no requirement for a surface protection layer (SPL) to be incorporated onto an outer surface of the blade 5 or any need to concentrate efforts on successfully transitioning the current across the connector 41 to the inboard blade portion 22.

FIG. 7 shows an example in which the inboard blade portion 22 does not form part of the lightning strike protection system. In other words, the inboard blade portion 22 is not intended to carry lightning current. The inboard blade portion 22 therefore does not form part of the lightning strike protection system.

In alternative examples, the inboard blade portion 22 may form part of the lightning strike protection system but in a reduced capacity. For instance, the inboard portion of each wind turbine blade 5 may have part of the lightning strike protection system configured to carry a reduced lightning current in comparison to the lightning current that the part of the lightning strike protection system on the outboard blade portion 24 is configured to carry. An example is shown in FIG. 8, in which a second down conductor 70a, e.g. a down conductor cable, extends through the inboard blade portion 22 from the connector 41 to the hub 4. The second down conductor 70a has a greater impedance than the first down conductor 70. This may result in a major portion of the lightning current being directed via the conductive material of the connecting members 6 rather than via the second down conductor 70a. This can provide substantial benefits in terms of the reduced mass and cost of the inboard blade portion 22 due to the wider range of suitable materials that may be used, as well as reduced manufacturing costs that might otherwise be incurred in ensuring the second down conductor 70a is able to carry the full capacity of any lightning current.

FIG. 9 shows an example in which the connecting member 6 or pre-tension member 8 includes the conductive material formed as a plurality of conductive strands 81 embedded within the main load bearing material 80. The main load bearing material 80 may be a polymer material.

FIG. 10 shows an alternative example in which the conductive material formed as a cable 82 is attached to or embedded within the main load bearing material 80 of the connecting member 6 or pre-tension member 8. The main load bearing material 80 may be a polymer material. The cable 82 is shown adjacent an outer surface 6a of the connecting member 6, although it will be appreciated that the cable 82 may be embedded anywhere within the connecting member 6.

In this context, embedded may refer to the strands 81 or cable 82 of conductive material being attached to the main load bearing material 80 so as to experience the same axial strain, although it will be appreciated that the strands 81 and cable 82 may be axially moveable relative to the main load bearing material 80.

In these examples, the conductive material is coupled inside a profile of the load bearing material 80 of the connecting member 6 or pre-tension member 8, however the conductive material may be coupled outside the profile of the load bearing material 80 of the connecting member 6 or pre-tension member 8, e.g. such that the conductive material is isolated from the loads of the connecting member 6 or pre-tension member 8.

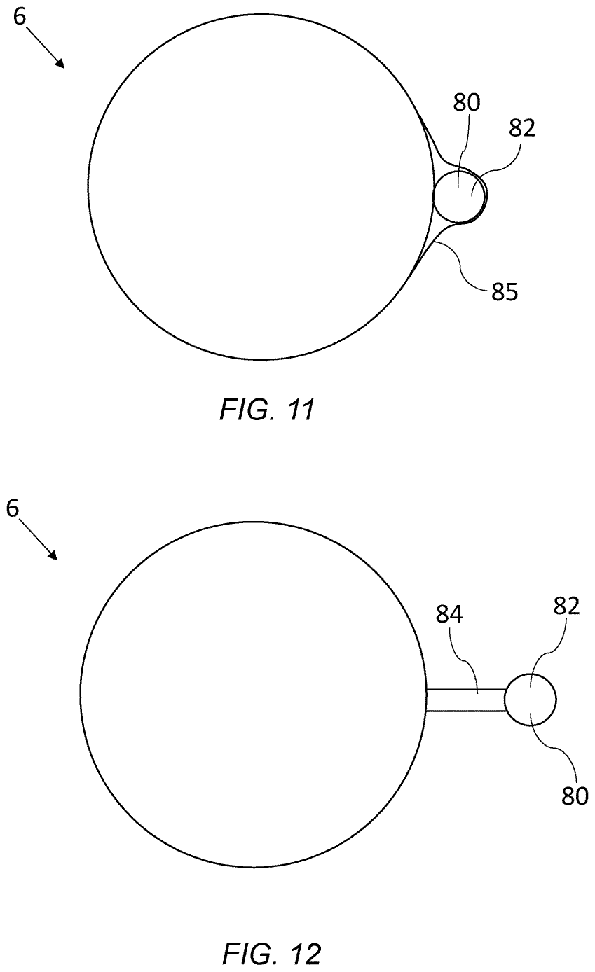

In some examples, the conductive material may be attached to an outer surface 6a of the blade connecting member 6 or pre-tension member 8. This can allow the conductive material to be added to the connecting member 6 or pre-tension member 8 after the connecting member 6 or pre-tension member 8 has been fabricated, or retrofitted to an existing connecting member 6 or pre-tension member 8. The conductive material may be fixed to the connecting member 6 or pre-tension member 8 at one or more points, or connected substantially along the entire length of the connecting member 6 or pre-tension member 8. A connecting material 85 may overlay the conductive material, e.g. cable 82, as shown by way of example in FIG. 11, or a connecting material may be wrapped around the entire connecting member 6 or pre-tension member 8 or otherwise be provided between the conductive material and the connecting member 6 or pre-tension member 8. The connecting material 85 provides a means of attaching the conductive material to the connecting member 6. In addition, by overlaying the conductive material, the connecting material 85 can protect the conductive material from damage, e.g., impact and abrasion damage, and provide UV protection. The connecting material 85 may be adhesively attached to the connecting member 6. The connecting material 85 may be co-cured to the connecting member 6.

The connecting material 85 may be a cable tie or include hook and loop fastenings. The connecting material 85 may be formed of a polymer material or other suitable material.

FIG. 12 shows an example in which the conductive material, e.g. cable 82, is separated or spaced from the connecting member 6 by a stand-off 84, such that the lightning current which can flow through the cable 82 is isolated from the connecting member 6 or pre-tension member 8. In alternative examples, an insulating layer, or similar, may be positioned between the conductive material and the connecting member 6 or pre-tension member 8.

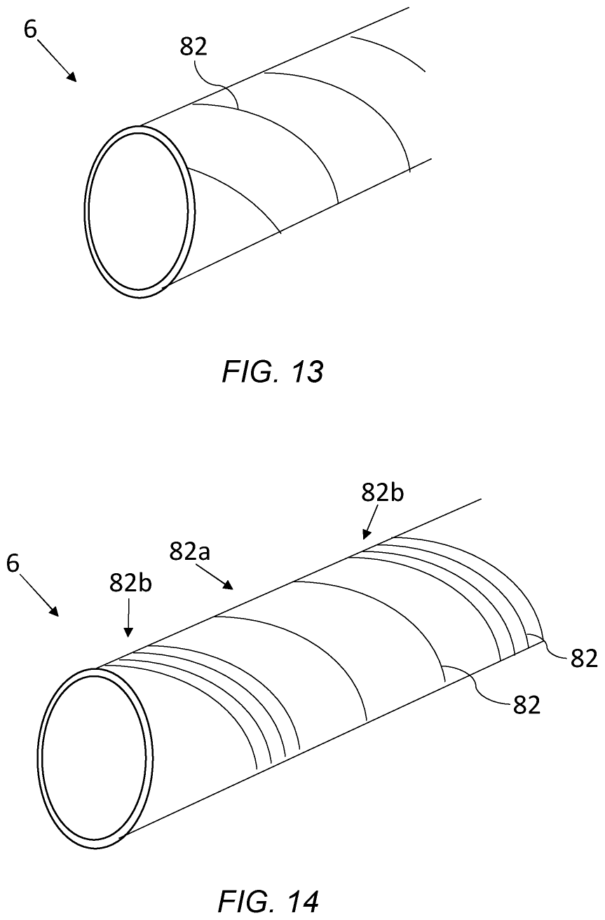

The conductive material may be helically wound around the connecting member 6 or pre-tension member 8. For instance, a cable 82 may be helically wound along the connecting member 6 or pre-tension member 8. The conductive material, e.g. cable 82 may be adhesively attached to the connecting member 6 or pre-tension member 8. This can increase the effective axial extensibility of the conductive material due to the helical angle of the conductive material relative to the load path through the connecting member 6 or pre-tension member 8. This can be beneficial when the connecting members 6 or pre-tension member 8 and the conductive material are different materials, as their material properties (e.g. coefficient of thermal expansion and tensile properties) will be different. FIG. 13 shows an example in which the conductive material formed as a plurality of cables 82 are helically wound around the connecting member 6 or pre-tension member 8.

The pitch of the helically wound conductive material can affect the behaviour of the conductive material, as a cable 82 having a comparatively larger pitch will have a shorter overall length, and therefore a shorter conductive path, but will accommodate less axial expansion of the connecting member 6 or pre-tension member 8 before the cable 82 is axially stretched by axial extension of the connecting member 6 or pre-tension member 8.

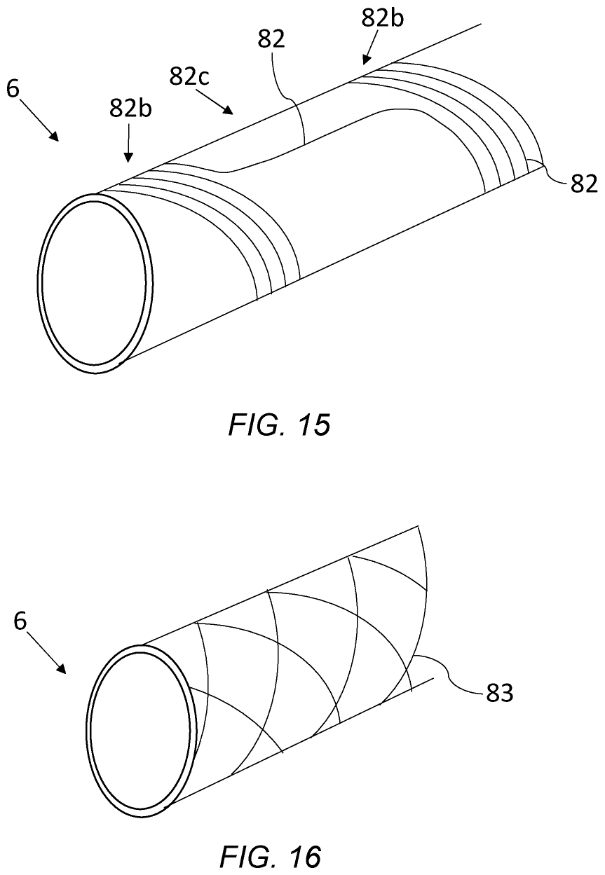

In some examples, the conductive material may have regions of different pitches. FIG. 14 shows an example in which conductive material formed as a cable 82 includes a first region 82a in having a first pitch positioned between two adjacent regions 82b having a comparatively small pitch. The adjacent regions 82b can act as ‘springs’ to account for any excessive axial strain of the connecting member 6 or pre-tension member 8, whilst the first region 82a helps to shorten the overall length of the cable 82. It will be appreciated that in alternate examples the conductive material may be helically wound in only some regions 82b of the connecting member 6, such that the conductive material in other regions 83c of the connecting member 6 extends substantially co-axially with the longitudinal axis of the connecting member 6. An example of this arrangement is shown in FIG. 15.

It will be appreciated that discussion of a cable 82 may refer to either a solid cable or a stranded cable.

In some examples, the conductive material may be provided in the form of a braided sleeve 83 that envelopes the connecting member 6 or pre-tension member 8, such that the conductive material is a braided hollow shield. The braided pattern may help prevent the conductive material from unravelling from the connecting member 6 or pre-tension member 8 due to the interlocking pattern of the strands that form the braided sleeve 83. The braided sleeve 83 may also protect the connecting member 6, for example by providing UV protection. An example of a braided sleeve 83 is shown in FIG. 16.

The examples shown in FIG. 9 to 16 are shown in relation to a connecting member 6, although it will be appreciated that the examples apply in the same way to a pre-tension member 8.

Although the invention has been described above with reference to one or more preferred embodiments, it will be appreciated that various changes or modifications may be made without departing from the scope of the invention as defined in the appended claims

1. A pitch controlled wind turbine comprising a tower, a nacelle mounted on the tower, a hub mounted rotatably on the nacelle, and at least three wind turbine blades, wherein each wind turbine blade extends between a root end connected to the hub via a pitch mechanism, and a tip end;
the wind turbine further comprising at least three blade connecting members, each blade connecting member extending from a connection point on one wind turbine blade towards a connection point on a neighboring wind turbine blade, where the connection point on a given wind turbine blade is arranged at a distance from the root end and at a distance from the tip end of the wind turbine blade;
each wind turbine blade comprising an outboard portion extending the distance from the tip end of the wind turbine blade to the connection point, and an inboard portion extending the distance from the root end of the wind turbine blade to the connection point;
wherein the wind turbine further comprises a lightning strike protection system and each blade connecting member has a conductive material configured to carry lightning current from the outboard portion of the wind turbine blade from which the connecting member extends and along a path extending with the blade connecting member towards the tower.

2. A pitch controlled wind turbine according to claim 1, wherein the wind turbine further comprises at least three pre-tension members, each pre-tension member being connected to one of the blade connecting members and to the hub, each pre-tension member thereby providing pre-tension in the blade connecting member to which it is connected, and wherein each pre-tension member has a conductive material forming part of the lightning strike protection system and configured to carry lightning current from the blade connecting member to which the pre-tension member is connected and along a path extending with the pre-tension member towards the tower.

3. A pitch controlled wind turbine according to claim 1, wherein the conductive material of the blade connecting members and/or the pre-tension members is embedded within the respective blade connecting member or pre-tension member.

4. A pitch controlled wind turbine according to claim 1, wherein the conductive material of the blade connecting members and/or the pre-tension members is attached to an outer surface of the respective blade connecting member or pre-tension member.

5. A pitch controlled wind turbine according to claim 4, wherein the conductive material is coupled to the respective blade connecting member or pre-tension member either inside or outside a profile of the respective blade connecting member or pre-tension member.

6. A pitch controlled wind turbine according to claim 5, wherein the conductive material is coupled to the outside of the profile of the respective blade connecting member or pre-tension member by a stand-off.

7. A pitch controlled wind turbine according to claim 1, wherein the conductive material is formed as one or more of a plurality of strands, a cable, or a braided sleeve.

8. A pitch controlled wind turbine according to claim 1, wherein the conductive material is helically wound along the respective blade connecting member or pre-tension member.

9. A pitch controlled wind turbine according to claim 8, wherein, in a first region of the respective blade connecting member or pre-tension member, the conductive material is helically wound, and at a second region of the respective blade connecting member or pre-tension member, the conductive material extends generally co-axially to a longitudinal axis of the respective blade connecting member or pre-tension member.

10. A pitch controlled wind turbine according to claim 8, wherein the conductive material is helically wound at a first pitch at a first region of the respective blade connecting member or pre-tension member and the conductive material is helically wound at a second pitch, different than the first pitch, at a second region of the respective blade connecting member or pre-tension member.

11. A pitch controlled wind turbine according to claim 1, wherein the blade connecting members and/or the pre-tension members comprise metallic material and the metallic material is the conductive material of the blade connecting members and/or the pre-tension members.

12. A pitch controlled wind turbine according to claim 1, wherein the blade connecting members and/or the pre-tension members comprise polymer material.

13. A pitch controlled wind turbine according to claim 1, wherein the outboard portion and the inboard portion of each wind turbine blade are connected to each other at a split position, and wherein the connection points on the wind turbine blades are arranged at the split positions.

14. A pitch controlled wind turbine according to claim 1, wherein the inboard portion of each wind turbine blade has a reduced lightning current carrying capacity in comparison to a lightning current carrying capacity of the outboard portion of the wind turbine blade.

15. A pitch controlled wind turbine according to claim 1, wherein the inboard portion of each wind turbine blade is not configured to carry lightning current from the outboard portion of the wind turbine blade towards the tower.

16. A pitch controlled wind turbine comprising a tower, a nacelle mounted on the tower, a hub mounted rotatably on the nacelle, and at least three wind turbine blades, wherein each wind turbine blade extends between a root end connected to the hub via a pitch mechanism, and a tip end; the wind turbine further comprising:
at least three blade connecting members, each blade connecting member extending from a connection point on one of the at least three wind turbine blades towards a connection point on a neighboring wind turbine blade of the at least three wind turbine blades, where the connection point on a given wind turbine blade is arranged at a distance from the root end and at a distance from the tip end of the wind turbine blade; each wind turbine blade comprising an outboard portion extending the distance from the tip end of the wind turbine blade to the connection point, and an inboard portion extending the distance from the root end of the wind turbine blade to the connection point;
a lightning strike protection system and at least one of the blade connecting member has a conductive material configured to carry lightning current from the outboard portion of the wind turbine blade from which the connecting member extends and along a path extending with the blade connecting member towards the tower; and
at least three pre-tension members, each pre-tension member being connected to one of the blade connecting members and to the hub, each pre-tension member thereby providing pre-tension in the blade connecting member to which it is connected, and wherein each pre-tension member has a conductive material forming part of the lightning strike protection system and configured to carry lightning current from the blade connecting member to which the pre-tension member is connected and along a path extending with the pre-tension member towards the tower; wherein the conductive material of the blade connecting members and/or the pre-tension members is embedded within the respective blade connecting member or pre-tension member.
